(19) United States
(12) Patent Application Publication
(10) Pub. No.: US 2026/0158788 A1
(43) Pub. Date: Jun. 11, 2026

(54) INKJET RECORDING APPARATUS

(71) Applicant: KYOCERA Document Solutions Inc., Osaka (JP)

(72) Inventor: Masafumi SAITO, Osaka (JP)

(73) Assignee: KYOCERA Document Solutions Inc., Osaka (JP)

(21) Appl. No.: 19/397,596

(22) Filed: Nov. 21, 2025

(30) Foreign Application Priority Data
Dec. 5, 2024 (JP) 2024-212531

(51) Int. Cl. B41J 2/165

(52) U.S. Cl. CPC B41J 2/16552; B41J 2002/16558; B41J 2002/16573; B41P 2235/21

(57) ABSTRACT

An inkjet recording apparatus performs cleaning operation for an ink ejection face, in which control proceeds so as to perform first wiping operation to eject ink to the ink ejection face followed by second wiping operation to supply cleaning liquid to the ink ejection face performed last to thereby complete the cleaning operation. The wiping speed in the first wiping operation is equal to or more than that in the second wiping operation. The wiping speed Wc [mm/s] for the cleaning liquid in the last, second wiping operation in the cleaning operation relative to the viscosity Vc [mPa·s] of the cleaning liquid satisfies formula (1) below:

log Vc≥(−4×Wc+670)/1000 (1)

### INCORPORATION BY REFERENCE

This application is based on and claims the benefit of priority from Japanese Patent Application No. 2024-212531 filed on Dec. 5, 2024, the contents of which are hereby incorporated by reference.

### BACKGROUND

The present disclosure relates to an inkjet recording apparatus.

As recording apparatuses such as printers or copiers, inkjet recording apparatuses are commonly used that record an image by ejecting ink to a recording medium such as a sheet because they can record a high-definition image. In such an inkjet recording apparatus, ink left on an ink ejecting face of a recording head may solidify to cause ejection failure. To cope with this, a known technology for removing the ink that has solidified on the ink ejection face involves subjecting the ink ejection face to capping, immersion in a cleaning liquid, and cleaning (wiping).

### SUMMARY

According to one aspect of the present disclosure, an inkjet recording apparatus includes a recording head, a cleaning liquid supplying portion, a wiping unit, and a control portion. The recording head has an ink ejection face having a nozzle open in it through which to eject ink to a recording medium. The cleaning liquid supplying portion supplies cleaning liquid to the ink ejection face. The wiping unit has a blade that cleans the ink ejection face. The control portion controls the operation of the recording head, the cleaning liquid supplying portion, and the wiping unit. The control portion can perform cleaning operation to clean the ink ejection face through a combination of first wiping operation where only the ink is ejected to the ink ejection face, or the ink is ejected to and in addition the cleaning liquid is supplied to the ink ejection face, to be wiped off by the blade and second wiping operation where only the cleaning liquid is supplied to the ink ejection face to be wiped off by the blade. In the cleaning operation, control proceeds so as to perform the first wiping operation followed by the second wiping operation performed last to thereby complete the cleaning operation. The wiping speed in the first wiping operation is equal to or more than that in the second wiping operation. The wiping speed Wc [mm/s] for the cleaning liquid in the last, second wiping operation in the cleaning operation relative to the viscosity Vc [mPa·s] of the cleaning liquid is a speed that satisfies formula (1) below:

log Vc≥(−4×Wc+670)/1000 (1)

### BRIEF DESCRIPTION OF THE DRAWINGS

FIG. 1 is a schematical sectional front view of an inkjet recording apparatus according to one embodiment of the present disclosure.

FIG. 2 is a plan view around a recording portion in the inkjet recording apparatus in FIG. 1.

FIG. 3 is a block diagram showing a schematic configuration of the inkjet recording apparatus in FIG. 1.

FIG. 4 is a side view of a recording head in FIG. 2.

FIG. 5 is a bottom view of the recording head in FIG. 2.

FIG. 6 is a perspective part view of a head unit in FIG. 2.

FIG. 7 is a flow chart showing one example of cleaning operation for an ink ejection face in the inkjet recording apparatus in FIG. 1.

FIG. 8 is an illustrative diagram of first wiping operation in the inkjet recording apparatus in FIG. 1, being a side view showing a state where a wiping unit is arranged below the recording head.

FIG. 9 is a side view showing a state where, from the state shown in FIG. 8, the wiping unit has been moved upward into contact with a cleaning liquid supplying portion and where ink is purged to the ink ejection face.

FIG. 10 is a side view showing a state where, from the state shown in FIG. 9, a blade has been started to move toward the ink ejection face with the ink held on the ink ejection face.

FIG. 11 is a side view showing a state where, from the state shown in FIG. 10, the blade has been moved farther along the ink ejection face.

FIG. 12 is an illustrative diagram of second wiping operation in the inkjet recording apparatus in FIG. 1, being a side view showing a state where the wiping unit is in contact with the cleaning liquid supplying portion and where cleaning liquid is supplied to the cleaning liquid supplying face.

FIG. 13 is a side view showing a state where, from the state shown in FIG. 12, with the cleaning liquid held on the cleaning liquid supplying face, the blade has been moved toward the ink ejection face.

FIG. 14 is an illustrative diagram of a modified example of the first wiping operation in the inkjet recording apparatus in FIG. 1, being a side view showing a state where the ink is purged to the ink ejection face and where the cleaning liquid is supplied to the cleaning liquid supplying face.

FIG. 15 is a side view showing a state where, from the state shown in FIG. 14, with the ink held on the ink ejection face and with the cleaning liquid held on the cleaning liquid supplying face, the blade has been moved toward the ink ejection face.

### DETAILED DESCRIPTION

An embodiment of the present disclosure will be described below with reference to the accompanying drawings. Note that the description below is not meant as any limitation on the present disclosure.

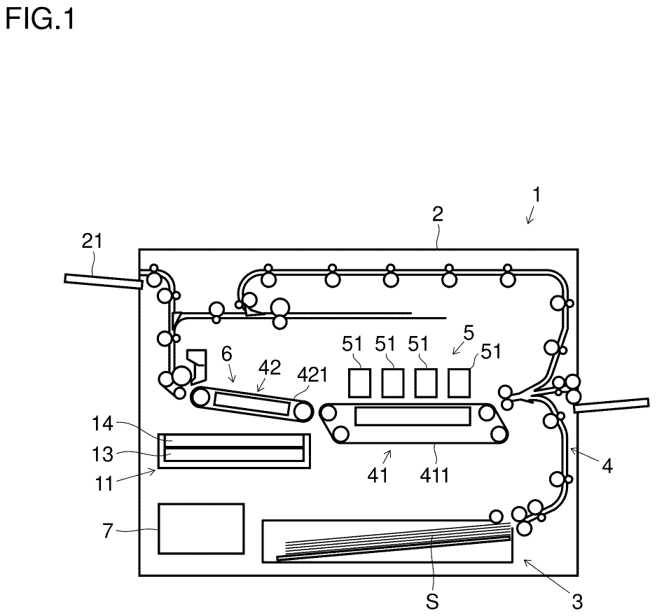

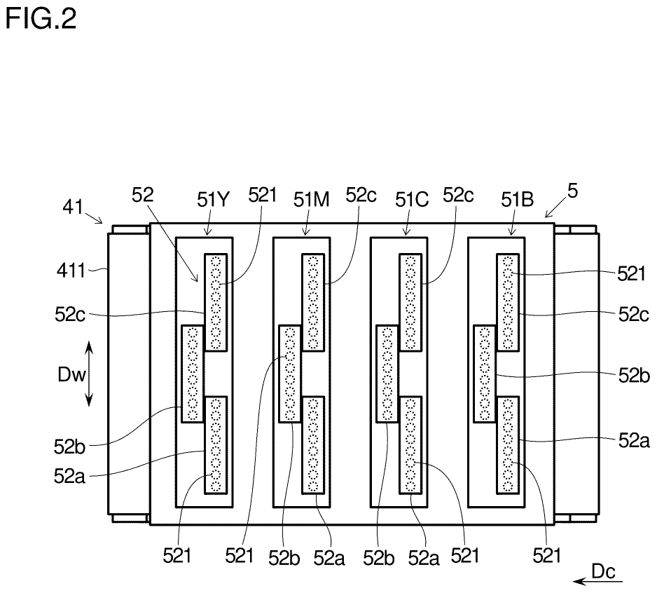

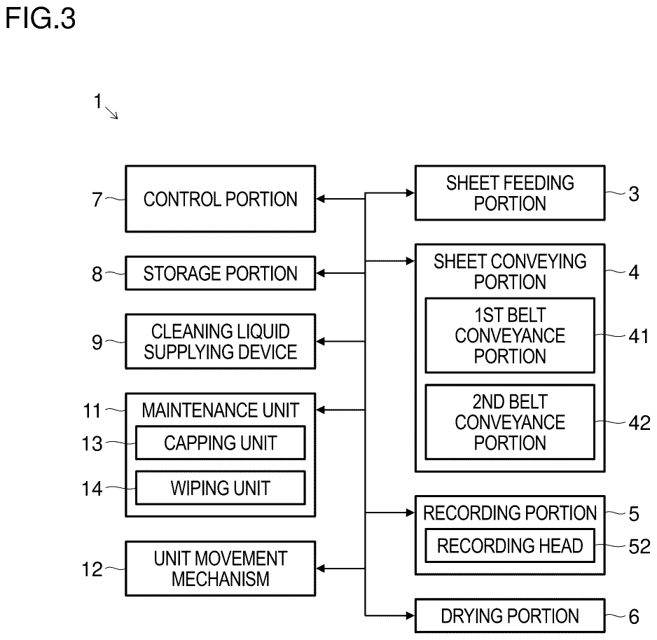

FIG. 1 is a schematical sectional front view of an inkjet recording apparatus 1 according to an embodiment. FIG. 2 is a plan view around a recording portion 5 in the inkjet recording apparatus 1 in FIG. 1. FIG. 3 is a block diagram showing a schematic configuration of the inkjet recording apparatus 1 in FIG. 1. The inkjet recording apparatus 1 is, for example, a printer employing an inkjet recording system. The inkjet recording apparatus 1 includes, as shown in FIGS. 1, 2, and 3, an apparatus body 2, a sheet feeding portion 3, a sheet conveying portion 4, a recording portion 5, a drying portion 6, a control portion 7, and a storage portion 8.

The sheet feeding portion 3 is arranged, for example, in a lower part of the apparatus body 2. The sheet feeding portion 3 stores a plurality of sheets (recording medium) S and separates and feeds out one sheet S after another during recording.

The sheet conveying portion 4 is arranged downstream of the sheet feeding portion 3 in the sheet conveyance direction and conveys the sheet S fed out from the sheet feeding portion 3. The sheet conveying portion 4 conveys the sheet S to the recording portion 5 and the drying portion 6 and discharges the sheet S subjected to recording and drying to a sheet discharging portion 21.

The sheet conveying portion 4 includes a first belt conveyance portion 41 and a second belt conveyance portion 42. The first belt conveyance portion 41 has a first conveyance belt 411 in an endless form. The second belt conveyance portion 42 has a second conveyance belt 421 in an endless form. The first and second belt conveyance portions 41 and 42 convey the sheet S while holding it by suction on their respective upper outer face (top face) of the first and second conveyance belts 411 and 421. The first belt conveyance portion 41 is arranged below the recording portion 5 and conveys the sheet S. The second belt conveyance portion 42, provided downstream of the first belt conveyance portion 41 in the sheet conveyance direction, is arranged in the drying portion 6 and conveys the sheet S.

The recording portion 5 is provided downstream of the sheet feeding portion 3 in the sheet conveyance direction and faces the first belt conveyance portion 41. The recording portion 5 faces the sheet S conveyed while being held by suction on the upper face of the first conveyance belt 411 and is provided above the first conveyance belt 411 across a predetermined interval. That is, the recording portion 5 faces the sheet S conveyed by the sheet conveying portion 4.

As shown in FIG. 2, the recording portion 5 has head units 51B, 51C, 51M, and 51Y respectively corresponding to four colors, namely black, cyan, magenta, and yellow. The head units 51B, 51C, 51M, and 51Y are arranged side by side along the sheet conveyance direction Dc such that their longitudinal directions are parallel to the sheet width direction Dw orthogonal to the sheet conveyance direction Dc. Note that, since the four head units 51B, 51C, 51M, and 51Y have basically the same configuration, in the description below, unless distinction is needed, the suffixes B, C, M, or Y for different colors may be omitted.

The head unit 51 for each color has a recording head 52 for a line inkjet system. In the head unit 51 for each color, a plurality of (e.g., three (52a, 52b, and 52c)) recording heads 52 are arrayed in a staggered formation along the sheet width direction Dw.

The recording head 52 has a plurality of ink ejection nozzles 521 in a bottom part of it. The plurality of ink ejection nozzles 521 are arranged in a row along the sheet width direction Dw, so that they can eject ink over the entire area of the recording region on the sheet S. That is, the recording head 52 has a plurality of ink ejection nozzles 521 that eject ink to the sheet S. The recording portion 5 records a full color image or a monochrome image on the sheet S by ejecting ink from the respective recording heads 52 of the head units 51B, 51C, 51M, and 51Y for the four colors successively to the sheet S being conveyed by the first conveyance belt 411.

The drying portion 6 is arranged downstream of the recording portion 5 in the sheet conveyance direction and is provided with the second belt conveyance portion 42. The sheet S having an ink image recorded on it in the recording portion 5 is held by suction by the second conveyance belt 421 in the drying portion 6 and is conveyed, and meanwhile the ink is dried.

The control portion 7 includes a CPU and other electronic circuits and components (of which none is shown). Based on programs or data for control stored in the storage portion 8, the CPU controls different components in the inkjet recording apparatus 1 to perform processes related to the functions of the inkjet recording apparatus 1. The sheet feeding portion 3, the sheet conveying portion 4, the recording portion 5, and the drying portion 6 individually receive commands from the control portion 7 and cooperate to perform recording on the sheet S.

The storage portion 8 is configured as a combination of a nonvolatile memory such as a program ROM (read-only memory) and a data ROM and a volatile memory such as a RAM (random-access memory).

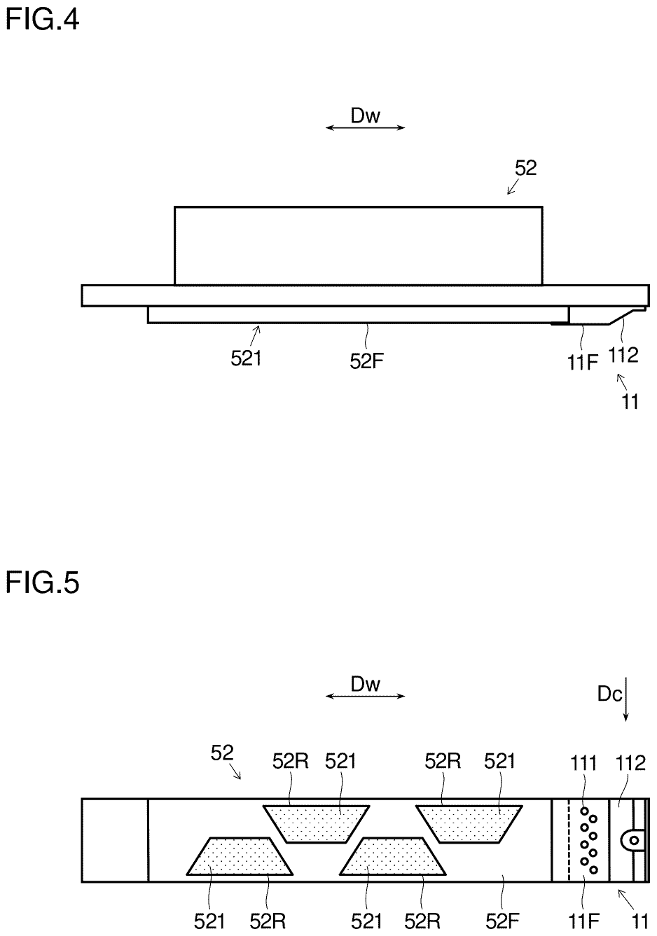

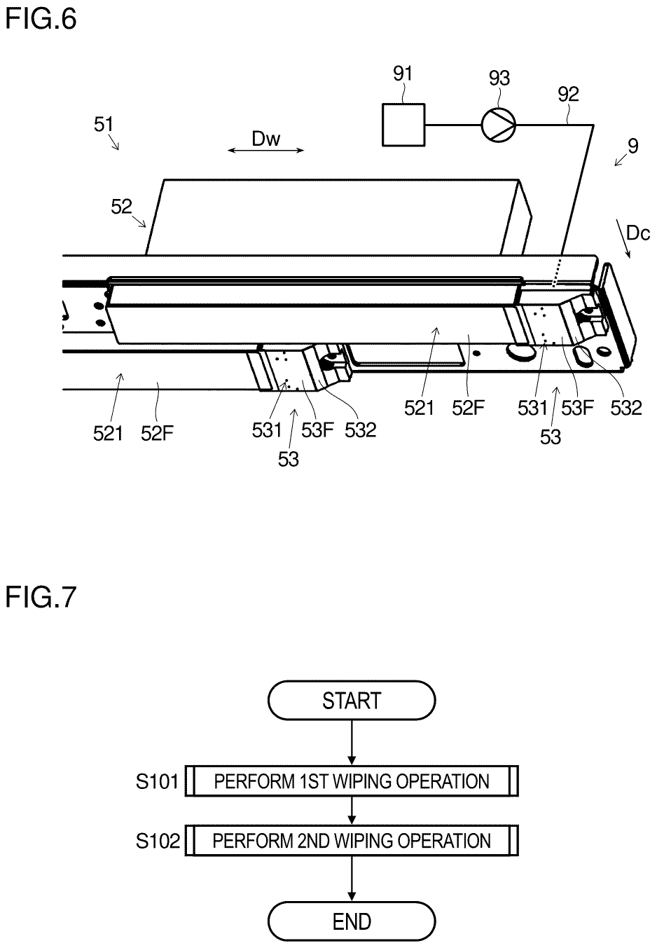

Next, the configurations of the head unit 51 and the recording head 52 in the recording portion 5 will be described. FIGS. 4 and 5 are a side view and a bottom view, respectively, of the recording head 52 in FIG. 2. FIG. 6 is a perspective part view of the head unit 51 in FIG. 2. Note that, since the three recording heads 52a, 52b, and 52c for each color have the same shape and configuration, in the following description, the suffixes (a, b, and c) are omitted.

The recording head 52 has an ink ejection face 52F in the bottom face of it. The ink ejection face 52F faces the front side (top face) of the sheet S conveyed on the first conveyance belt 411. As shown in FIG. 5, the ink ejection face 52F has a nozzle region 52R in which a large number of ink ejection nozzles 521 are arrayed. That is, the ink ejection face 52F has a large number of ink ejection nozzles 521 open in it, through which ink is ejected onto the sheet S. The ink ejection face 52F has a water-repellent film (not shown) formed on it. The recording heads 52 for the four colors (black, cyan, magenta, and yellow) are respectively fed with the inks of the four colors stored in ink tanks outside the head units 51.

Based on a control signal from the control portion 7, the recording head 52 ejects, according to image data received from an external computer, ink from the ink ejection nozzles 521 to the sheet S conveyed while being held by suction on the conveyance face of the first conveyance belt 411. Specifically, the control portion 7 inputs to the recording head 52 an ejection drive signal set to have a predetermined drive voltage and a predetermined pulse width to drive the recording head 52 to eject ink from the ink ejection nozzles 521. In this way, on the sheet S on the first conveyance belt 411, a color image or a monochrome image having inks of the four colors, namely black, cyan, magenta, and yellow, overlayed on each other is formed.

As shown in FIGS. 3 and 6, the inkjet recording apparatus 1 further includes a cleaning liquid supplying device 9. The cleaning liquid supplying device 9 includes a tank 91, a flow passage 92, and a pump 93.

The tank 91 stores cleaning liquid. One end of the flow passage 92 is connected to the tank 91. The other end of the flow passage 92 is connected to a cleaning liquid supplying portion 53, which will be described later, of the recording head 52. The pump 93 is arranged downstream of the tank 91 in the cleaning liquid flow direction, in the flow passage 92. The pump 93 applies a pressure to the cleaning liquid in the flow passage 92 to move the cleaning liquid in the flow passage 92. Driving the pump 93 permits the cleaning liquid to be supplied from the tank 91 via the flow passage 92 to the cleaning liquid supplying portion 53 in the recording head 52.

The cleaning liquid is preferably a solution with components similar to those of ink except for a coloring material. The cleaning liquid is a liquid composition that is composed of a solvent component and water that is, as needed, blended with a surfactant, an antiseptic, an antifungal agent, and the like. The cleaning liquid is good at removing ink and dissolving solidified ink.

As shown in FIGS. 4, 5, and 6, the recording head 52 is provided with a cleaning liquid supplying portion 53. The cleaning liquid supplying portion 53 is arranged in a part of the recording head 52 at its one end along the sheet width direction Dw, adjacent to the ink ejection face 52F.

The cleaning liquid supplying portion 53 has a cleaning liquid supplying face 53F in a bottom face of it. The cleaning liquid supplying face 53F is parallel to the ink ejection face 52F and is adjacent to the ink ejection face 52F along the sheet width direction Dw. The region of the cleaning liquid supplying face 53F adjacent to the ink ejection face 52F is in the form of a thin plate and is placed below the ink ejection face 52F so as to overlap with it. The cleaning liquid supplying face 53F has a water-repellent film formed on it.

The cleaning liquid supplying face 53F has a plurality of cleaning liquid supplying ports 531 open in it. The plurality of cleaning liquid supplying ports 531 are arrayed, for example, in a staggered formation along the sheet conveyance direction Dc. The downstream end of the flow passage 92 of the cleaning liquid supplying device 9 in the cleaning liquid flow direction is connected to the cleaning liquid supplying ports 531. The cleaning liquid supplying ports 531 supply the cleaning liquid to the cleaning liquid supplying face 53F. The cleaning liquid is carried to the ink ejection face 52F by a blade 14B, which will be described later. In other words, the cleaning liquid supplying device 9 supplies the cleaning liquid to the ink ejection face 52F.

The cleaning liquid supplying portion 53 has a slope face 532. The slope face 532 is provided at the side of the cleaning liquid supplying face 53F opposite from the ink ejection face 52F along the sheet width direction Dw. The slope face 532 is formed with such an inclination as to be increasingly high the farther away from the ink ejection face 52F along the sheet width direction Dw.

As shown in FIGS. 1 and 3, the inkjet recording apparatus 1 includes a maintenance unit 11 and a unit movement mechanism 12. The maintenance unit 11 includes a capping unit 13 and a wiping unit 14.

The capping unit 13 has a cap portion (not shown). The cap portion is arranged one at each of positions corresponding to the plurality of recording heads 52a, 52b, and 52c for each color arrayed in a staggered formation along the sheet width direction Dw. The cap portion has a shape depressed downward. The cap portion is attachable and detachable to and from the ink ejection face 52F and covers the ink ejection face 52F.

When the maintenance of the recording head 52 is performed, the capping unit 13 is arranged in a capping position where it covers the ink ejection face 52F and is attached to the bottom face of the recording head 52. With the capping unit 13 arranged in the capping position, a bottom part of the recording head 52 fits in the cap portion, and, between the ink ejection face 52F and the cap portion, a closed space is formed.

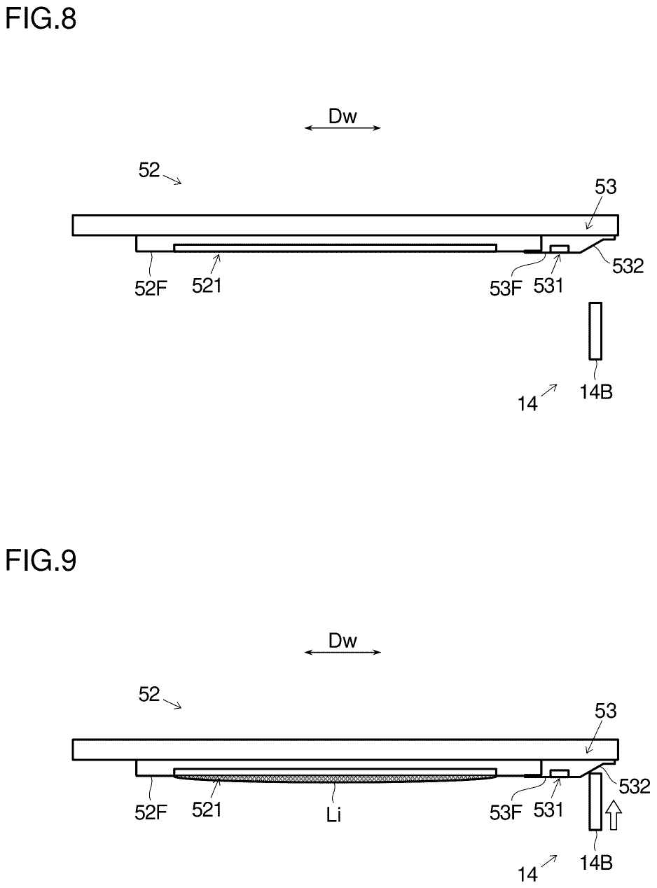

The wiping unit 14 has a liquid waste tray (not shown) and a blade 14B (see FIG. 8). The liquid waste tray has a depressed portion depressed downward to receive liquid waste (ink and cleaning liquid) wiped off from the ink ejection face 52F. The depressed portion is arranged one at each of positions corresponding to the plurality of recording heads 52a, 52b, and 52c for each color arrayed in a staggered formation along the sheet width direction Dw. The blade 14B is attached one to each of the three depressed portions so as to be movable along the sheet width direction Dw.

When the maintenance of the recording head 52 is performed, the wiping unit 14 is arranged below the ink ejection face 52F. The blade 14B moves along the sheet width direction Dw to wipe off the cleaning liquid supplied to the cleaning liquid supplying face 53F. In addition, the blade 14B moves along the sheet width direction Dw to wipe off the ink ejected to the ink ejection face 52F. The blade 14B can wipe off the ink ejected to the ink ejection face 52F with the cleaning liquid mixed with it. In this way, the wiping unit 14 cleans the ink ejection face 52F using the blade 14B.

The unit movement mechanism 12 includes an ascent/descent mechanism and a slide mechanism (none of which is shown). The ascent/descent mechanism and the slide mechanism are configured to include a motor, a guide rail, a group of gears, a wire (belt), a pulley, and the like. The capping unit 13 and the wiping unit 14 are supported by the ascent/descent mechanism and the slide mechanism of the unit movement mechanism 12 and are movable along the sheet conveyance direction Dc and along the top-bottom direction with respect to the head unit 51 (recording head 52). The operation of the unit movement mechanism 12 is controlled by the control portion 7.

When the maintenance of the recording head 52 is not being performed, the capping unit 13 and the wiping unit 14 are arranged, as shown in FIG. 1, in a retracted position below the drying portion 6.

In the inkjet recording apparatus 1, the maintenance of the recording head 52 is performed with predetermined timing. This maintenance of the recording head 52 is performed, for example, at the start of recording after a long period of disuse or between sessions of recording operation. When the maintenance of the recording head 52 is performed, the control portion 7 makes the unit movement mechanism 12 move the capping unit 13 and the wiping unit 14 to a maintenance position below the recording portion 5 (recording head 52).

When the maintenance of the recording head 52 is performed, the first belt conveyance portion 41 arranged opposite the bottom face of the recording portion 5 is retracted by a movement mechanism (not shown) for the first belt conveyance portion 41 to below the position shown in FIG. 1, to close to the sheet feeding portion 3. After that, the capping unit 13 and the wiping unit 14 are moved to the maintenance position below the recording portion 5 (recording head 52) and then to close to the ink ejection face 52F.

Next, the description will be given of, as part of the maintenance of the recording head 52, cleaning operation for the ink ejection face 52F performed using the wiping unit 14.

These days, water-based jet ink, which puts less burden on the environment is used even for non-absorbent recording media such as coated paper and a film. For increased wettability of a base material, ink tends to have increasingly low surface tension. Such ink with low surface tension strongly adheres to the ink ejection face 52F. This necessitates not only wiping operation using ink purging (forced ejection) but also wiping operation using only cleaning liquid with lower static surface tension than ink to remove the adhered ink.

Though depending on the condition of its drying, the adhered ink gets more difficult to remove, as it gets drier. This necessitates reducing the wiping speed to increase the time of contact between the adhered ink and cleaning liquid. Thus, typically, the blade 14B is given a width (dimension along the sheet conveyance direction Dc in FIG. 6) greater than the ink ejection face 52F to wipe across the entire surface of the ink ejection face 52F.

Owing to this structure, the liquid (ink, cleaning liquid) involved in wiping can run across side parts of the blade 14B along the width direction, that is, parts of it not in contact with the ink ejection face 52F, to reach behind the blade 14B in its movement direction. This running of the liquid is more likely the lower the viscosity of the liquid or the lower the wiping speed. That is, if the wiping speed is reduced to remove dried adhered ink on the ink ejection face 52F, the liquid involved in wiping runs to behind the blade 14B in its movement direction and some of it is left unwiped. If ink is left unwiped around the ink ejection nozzles 521, it causes an ink ejection failure.

To cope with the inconvenience described above, the control portion 7 combines, in the cleaning operation for ink ejection face 52F, first wiping operation and second wiping operation to clean the ink ejection face. In the first wiping operation, only ink is ejected to the ink ejection face 52F, or cleaning liquid is supplied in addition to the ejection of ink to be wiped off by the blade 14B. In the second wiping operation, only cleaning liquid is supplied to the ink ejection face 52F to be wiped off by the blade 14B.

FIG. 7 is a flow chart showing one example of cleaning operation for the ink ejection face 52F in the inkjet recording apparatus 1 in FIG. 1. In the cleaning operation for the ink ejection face 52F, the control portion 7 controls so as to perform the first wiping operation (step S101) followed by the last, second wiping operation (step S102) to thereby end the cleaning operation. As will be described later, depending on the length of the period without recording, the control portion 7 can perform the second wiping operation (pretreatment) before step S101.

FIG. 8 is an illustrative diagram of the first wiping operation in the inkjet recording apparatus in FIG. 1, being a side view showing a state where the wiping unit 14 is arranged below the recording head 52. Note that FIGS. 8 to 15 only depict the components necessary for the description of the cleaning operation for the ink ejection face 52F and thus the other components are omitted from illustration. Specifically, in FIG. 8, the blade 14B is arranged below the cleaning liquid supplying portion 53.

FIG. 9 is a side view showing a state where, from the state shown in FIG. 8, the wiping unit 14 has been moved upward into contact with the cleaning liquid supplying portion 53 and where ink Li is purged to the ink ejection face 52F. Then, as shown in FIG. 9, the wiping unit 14 is moved upward into contact with the slope face 532 of the cleaning liquid supplying portion 53 under a predetermined pressure.

The ink Li is then ejected from the ink ejection nozzles 521 to the ink ejection face 52F. The ink Li contains, for example, ink with high viscosity, foreign matter, air bubbles, and the like in the ink ejection nozzles 521 and is forced to be pushed (i.e., purged) out of the ink ejection nozzles 521. The ink Li is held by its surface tension under the ink ejection face 52F across a predetermined length along the sheet width direction Dw over the entire area of the ink ejection face 52F along the sheet convenance direction Dc (the front-back direction of the plane of FIG. 9).

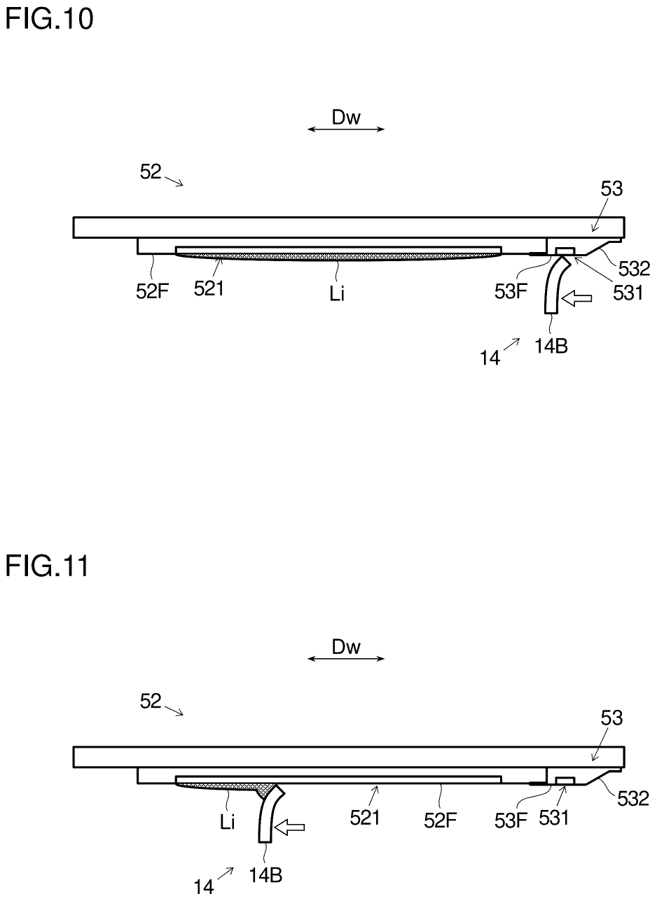

FIG. 10 is a side view showing a state where, from the state shown in FIG. 9, the blade 14B has been started to move toward the ink ejection face 52F with the ink Li held on the ink ejection face 52F. Then, as shown in FIG. 10, the blade 14B, with its upper end in contact with the slope face 532 of the cleaning liquid supplying portion 53, is moved along the cleaning liquid supplying face 53F toward the ink ejection face 52F along the sheet width direction Dw.

FIG. 11 is a side view showing a state where, from the state shown in FIG. 10, the blade 14B has been moved farther along the ink ejection face 52F. Then, as shown in FIG. 11, the ink Li on the ink ejection face 52F is wiped off by the blade 14B moved along the sheet width direction Dw.

When the blade 14B reaches the downstream end of the ink ejection face 52F along its movement direction (i.e., the side opposite from the cleaning liquid supplying portion 53 along the sheet width direction Dw), it stops being moved. Then, the blade 14B (wiping unit 14) is lowered and moved apart from the ink ejection face 52F. The ink Li wiped off by the blade 14B is collected in the depressed portion of the liquid waste tray in the wiping unit 14.

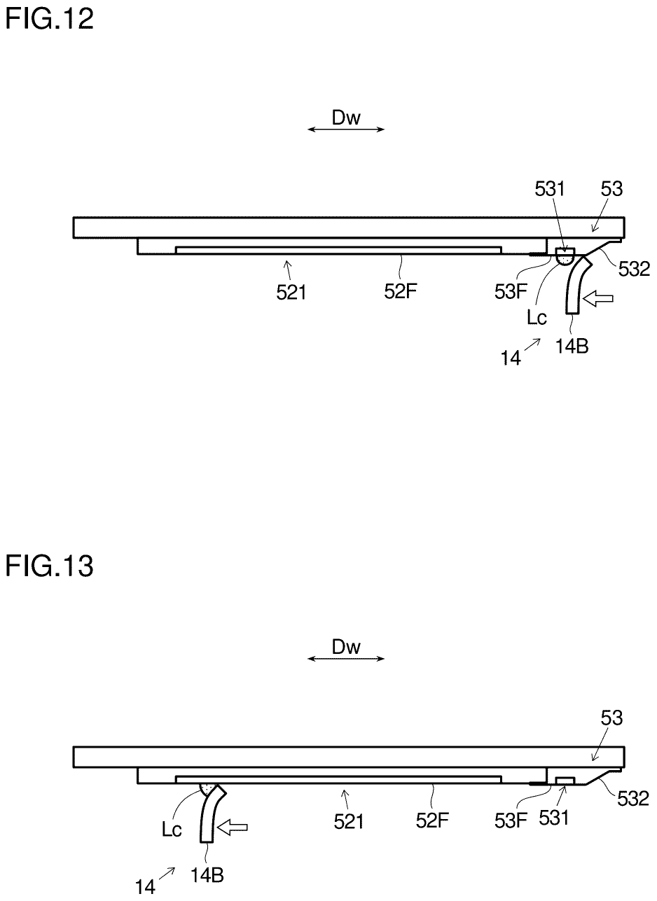

FIG. 12 is an illustrative diagram of the second wiping operation in the inkjet recording apparatus 1 in FIG. 1, being a side view showing a state where the wiping unit 14 is in contact with the cleaning liquid supplying portion 53 and where cleaning liquid Lc is supplied to the cleaning liquid supplying face 53F. Specifically, the blade 14B is in contact with the slope face 532 of the cleaning liquid supplying portion 53 under a predetermined pressure, and, as shown in FIG. 12, the blade 14B is moved along the cleaning liquid supplying face 53F toward the ink ejection face 52F along the sheet width direction Dw.

The cleaning liquid supplying face 53F is supplied with cleaning liquid Lc from the cleaning liquid supplying ports 531. The cleaning liquid Lc is held by its surface tension under the cleaning liquid supplying face 53F across a predetermined length along the sheet width direction Dw over the entire area of the cleaning liquid supplying face 53F along the sheet conveyance direction Dc (the front-back direction of the plane of FIG. 12).

FIG. 13 is a side view showing a state where, from the state shown in FIG. 12, with the cleaning liquid Lc held on the cleaning liquid supplying face 53F, the blade 14B has been moved toward the ink ejection face 52F. Then, the blade 14B wipes off the cleaning liquid Lc on the cleaning liquid supplying face 53F and carries the cleaning liquid Lc to the ink ejection face 52F. After that, as shown in FIG. 13, the cleaning liquid Lc carried to the ink ejection face 52F is wiped off by the blade 14B moved along the sheet width direction Dw.

When the blade 14B reaches the downstream end of the ink ejection face 52F along its movement direction (i.e., the side opposite from the cleaning liquid supplying portion 53 along the sheet width direction Dw), it stops being moved. Then, the blade 14B (wiping unit 14) is lowered and moved apart from the ink ejection face 52F. The cleaning liquid Lc wiped off by the blade 14B is collected in the depressed portion of the liquid waste tray in the wiping unit 14.

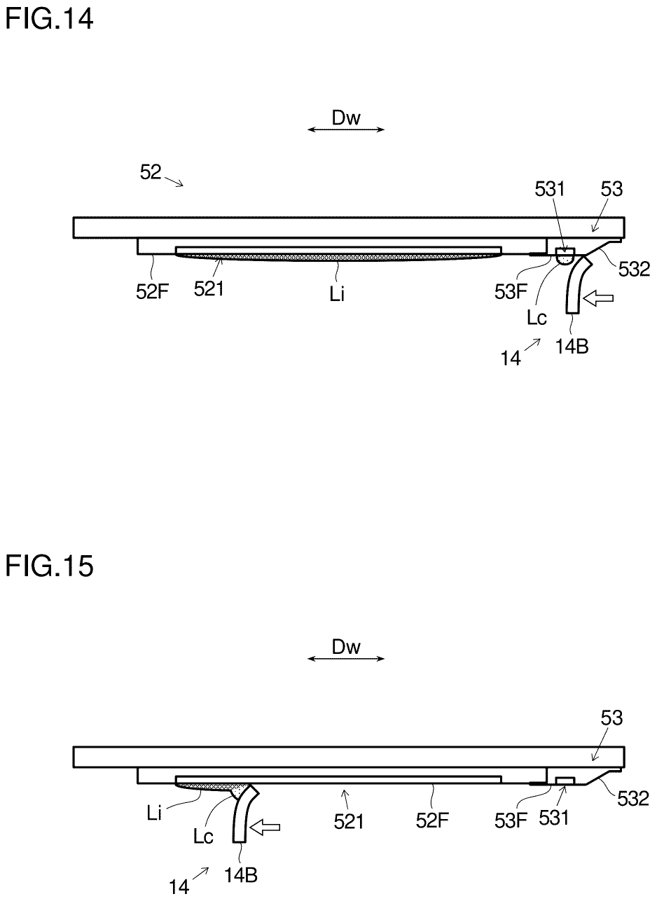

FIG. 14 is an illustrative diagram of a modified example of the first wiping operation in the inkjet recording apparatus 1 in FIG. 1, being a side view showing a state where the ink Li is purged to the ink ejection face 52F and where the cleaning liquid Lc is supplied to the cleaning liquid supplying face 53F. Specifically, the blade 14B is in contact with the slope face 532 of the cleaning liquid supplying portion 53 under a predetermined pressure, and, as shown in FIG. 14, the blade 14B is moved along the cleaning liquid supplying face 53F toward the ink ejection face 52F along the sheet width direction Dw.

To the cleaning liquid supplying face 53F, the cleaning liquid Lc is supplied from the cleaning liquid supplying ports 531. To the ink ejection face 52F, the ink Li is ejected from the ink ejection nozzles 521. The cleaning liquid Lc and the ink Li are held by their surface tension under the cleaning liquid supplying face 53F and the ink ejection face 52F across predetermined lengths along the sheet width direction Dw over the entire areas of the cleaning liquid supplying face 53F and the ink ejection face 52F along the sheet conveyance direction Dc (the front-back direction of the plane of FIG. 14).

FIG. 15 is a side view showing a state where, from the state shown in FIG. 14, with the ink Li held on the ink ejection face 52F and with the cleaning liquid Lc held on the cleaning liquid supplying face 53F, the blade 14B has been moved toward the ink ejection face 52F. Then, the blade 14B wipes off the cleaning liquid Lc on the cleaning liquid supplying face 53F and carries the cleaning liquid Lc to the ink ejection face 52F. After that, as shown in FIG. 15, the cleaning liquid Lc carried to the ink ejection face 52F is mixed with the ink Li ejected to and held on the ink ejection face 52F and the mixture is wiped off.

When the blade 14B reaches the downstream end of the ink ejection face 52F along its movement direction (i.e., the side opposite from the cleaning liquid supplying portion 53 along the sheet width direction Dw), it stops being moved. Then, the blade 14B (wiping unit 14) is lowered and moved apart from the ink ejection face 52F. The mixture liquid of the cleaning liquid Lc and the ink Li wiped off by the blade 14B is collected in the depressed portion of the liquid waste tray in the wiping unit 14.

In the cleaning operation for the ink ejection face 52F described above, the wiping speed of the blade 14B wiping the ink ejection face 52F in the first wiping operation is equal to or greater than that of the blade 14B wiping the ink ejection face 52F in the second wiping operation. Specifically, the wiping speed of the blade 14B wiping off when only the ink Li ejected to the ink ejection face 52F or the cleaning liquid Lc supplied to and the ink Li ejected to the ink ejection face 52F (i.e., the first wiping operation) is equal to or greater than that of the blade 14B wiping off only the cleaning liquid Lc supplied to the ink ejection face 52F (i.e., the second wiping operation). In other words, the wiping speed of the blade 14B wiping when the ink Li is ejected to the ink ejection face 52F is equal to or greater that that of the blade 14B when only the cleaning liquid Lc is supplied to the ink ejection face 52F.

The wiping speed Wc [mm/s] for the cleaning liquid Lc in the last, second wiping operation in the cleaning operation for the ink ejection face 52F relative to the viscosity Vc [mPa·s] of the cleaning liquid Lc is a speed that satisfies formula (1) below.

$$log Vc \geq ( - 4 \times Wc + 670 ) / 1000 \qquad ( 1 )$$

### Examples

The ink left unwiped on the ink ejection face 52F after cleaning was evaluated.

The inks used for evaluation were two types of water-based inks A and B. The cleaning liquid used for evaluation had properties shown in Table 1. Used as the cleaning liquid was a liquid which was the mixture of a viscosity modifier (1,3-propanediol), a surface tension modifier (Silface SAG503A, manufactured by Nissin Chemical Industry Co., Ltd.), a detergent (AQUALIC DL522, manufactured by NIPPON SHOKUBAI CO., LTD.), and deionized water. For the cleaning liquids, three types (Lc1, Lc2, and Lc3) containing different amounts of viscosity modifier (1,3-propanediol) were prepared. Cleaning liquids Lc1, Lc2, and Lc3 had viscosities of 2, 3, and 4 [mPa·s], respectively.

TABLE 1

| Cleaning Liquid | Lc1 | Lc2 | Lc3 |
|---|---|---|---|
| Viscosity Modifier | 25% | 36% | 45% |
| Surface Tension Modifier | 0.3% | 0.3% | 0.3% |
| Detergent | 0.2% | 0.2% | 0.2% |
| Deionized Water | Balance | Balance | Balance |
| Viscosity[mPa · s](25° C.) | 2 | 3 | 4 |

In the cleaning operation for the ink ejection face 52F, control proceeded so as to perform the first wiping operation (only ink ejected) followed by the second wiping operation (only cleaning liquid supplied) to thereby complete the cleaning operation and, after that, ink was ejected from the ink ejection nozzles 521. The ink left unwiped on the ink ejection face 52F was evaluated using the three types of cleaning liquid, namely Lc1, Lc2, and Lc3, while gradually changing the wiping speed of the last, second wiping operation. The evaluation was done individually for each of the two types of inks, A and B.

TABLE 2

| Cleaning Liquid | | | | | | | | | | | |
|---|---|---|---|---|---|---|---|---|---|---|---|
| | Viscosity | Second Wiping Operation Wiping Speed [mm/S] | | | | | | | | | |
| | [mPa · s] | 10 | 20 | 30 | 40 | 50 | 60 | 70 | 80 | 90 | 100 |
| Lc1 | 2 | — | | — | — | — | — | — | Poor | Poor | Good |
| Lc2 | 3 | — | — | Poor | Poor | Good | Good | Good | Good | Good | Good |
| Lc3 | 4 | Poor | Good | Good | Good | Good | Good | Good | — | — | — |

To obtain Table 2, ink was ejected from all the ink ejection nozzles 521 in the ink ejection face 52F to a sheet, and the sheet was visually checked; if no ejection failure was observed, it was judged that no ink was left unwiped, with “Good” given as an evaluation for ink left unwiped; and if an ejection failure was observed, it was judged that some ink was left unwiped, with “Poor” given as an evaluation for ink left unwiped.

Table 2 reveals that, for cleaning liquids Lc1, Lc2, and Lc3, the lower limit of the wiping speed Wc at which no ink is left unwiped on the ink ejection face 52F was 100 [mm/s], 50 [mm/s], and 20 [mm/s], respectively. Note that the evaluation results shown in Table 2 were the same for the two types of inks, A and B. Plotting the relationship between the viscosities Vc of these cleaning liquids Lc and the wiping speed Wc for the cleaning liquid Lc in the second wiping operation gives formula (1) above.

With the configuration described above, it is possible to set, at the last stage of the cleaning operation for the ink ejection face 52F, the wiping speed Wc that suits the viscosity Vc of the cleaning liquid Lc and that reduces the ink left unwiped on the ink ejection face 52F. It is thus possible to forcibly eject ink stagnating in the ink ejection nozzles 521 by the first wiping operation, and to prevent ink from being left in the nozzle parts of the ink ejection face 52F by the second wiping operation. This helps prevent ink ejection failure and helps maintain suitable ink ejection performance of the recording head 52.

Next, cleaning of the ink adhered on the ink ejection face 52F was evaluated.

As ink adhered on the ink ejection face 52F, one dot of ink was ejected on the ink ejection face 52F of the recording head 52 (KJ4B-1200, manufactured by Kyocera Document Solutions Inc.) to intentionally form adhered ink. An evaluation sample (sample) was formed with the ink adhered on the ink ejection face 52F placed in an environment for normal use, that is, at a temperature of 35° C. and a humidity of 15%. For ink A, three types of sample were prepared: evaluation sample Sp1 subjected to four-hour drying; evaluation sample Sp2 subjected to 24-hour drying for increased dryness and adherence of the ink; evaluation sample Sp3 subjected to 72-hour drying to be left to stand still for a long period. For ink B, two types of sample were prepared: evaluation sample Sp4 subjected to 24-hour drying for increased dryness and adherence of the ink; and evaluation sample Sp5 subjected to 72-hour drying to be left to stand still for a long period.

For the ink adhered on the ink ejection face 52F, the second wiping operation (with only cleaning liquid supplied) was performed at the lower-limit wiping speed according to Table 2 at which no ink was left unwiped and then the presence or absence of adhered ink was evaluated for the five types of evaluation sample, namely Sp1, Sp2, Sp3, Sp4, and Sp5.

TABLE 3

| Cleaning Liquid | | | | | | |
|---|---|---|---|---|---|---|
| | Wiping Speed | Adhered Ink Removal Evaluation Sample | | | | |
| | [mm/s] | Sp1 | Sp2 | Sp3 | Sp4 | Sp5 |
| Lc1 | 100 | Good | Poor | Poor | Good | Good |
| Lc2 | 50 | Good | Poor | Poor | Good | Good |
| Lc3 | 20 | Good | Good | Poor | Good | Good |
| Lc1 | 10 (Pretreatment), | — | — | Good | — | — |
| | 100 (Last) | | | | | |
| Lc3 | 10 (Pretreatment), | — | — | Good | — | — |
| | 20 (Last) | | | | | |

To obtain Table 3, the state of the ink ejection face 52F was visually checked before and after the second wiping operation; if the dot removal rate of adhered ink was 90% or more, “Good” was given as an evaluation for removal of adhered ink; and if the dot removal rate of adhered ink was less than 90%, “Poor” was given as an evaluation for removal of adhered ink.

According to Table 3, for evaluation samples Sp1, Sp4, and Sp5, the three types of cleaning liquid, Lc1, Lc2, and Lc3 were all Good in the dot removal rate of adhered ink at the lower-limit wiping speed that satisfies formula (1) above and at which no ink was left unwiped on the ink ejection face 52F. For evaluation sample Sp2, cleaning liquids Lc1 and Lc2 were Poor in the dot removal rate of adhered ink at the lower-limit wiping speed, the cleaning liquid Lc3 was Good in the dot removal rate of adhered ink at the lower-limit wiping speed.

In this way, in the cleaning operation for the ink ejection face 52F, performing the first wiping operation using ink purging (forced ejection) at a sufficiently high speed prevents purged ink ejected to the ink ejection face 52F from being left unwiped; and lastly performing the second wiping operation using only the cleaning liquid prevents adhered ink and purged ink from being left unwiped.

On the other hand, for evaluation sample Sp3, all the three types of cleaning liquid, Lc1, Lc2, and Lc3, were Poor in the dot removal rate of adhered ink at the lower-limit wiping speed. This seems to lead to a conclusion that the removability of the adhered ink for the ink used in this evaluation depends not on the viscosity of the cleaning liquid but on the wiping speed. A reduced wiping speed in the second wiping operation (only cleaning liquid supplied) may result in a higher removal rate of ink adhered on the ink ejection face 52F but, as described with Table 2, can cause ink to be left unwiped on the ink ejection face 52F.

Thus, when firmly adhered ink is considered to be present, it is preferable to perform pretreatment with the second wiping operation involving only the supply of cleaning liquid. That is, in the cleaning operation, after the second wiping operation (pretreatment) is performed at a speed lower than the wiping speed in the last, second wiping operation (only cleaning liquid supplied), the first wiping operation (ink ejection only) is performed followed by the last, second wiping operation to complete the cleaning operation. The wiping speed in the second wiping operation as the pretreatment is set, for example, at 10 [mm/s].

Table 3 reveals that, for evaluation sample Sp3, when the pretreatment mentioned above was performed with cleaning liquids Lc1 and Lc3, the dot removal rate of adhered ink on the ink ejection face 52F became Good. In this way, by performing the second wiping operation at a low speed as pretreatment before the first wiping operation, it is possible to dissolve firmly adhered ink. Thus, it is possible to remove from the ink ejection face 52F firmly adhered ink left to stand still for a long period.

In addition, the evaluation results above reveal that, the higher the viscosity of the cleaning liquid, the wider the range of the wiping speed usable in the last, second wiping operation (only cleaning liquid supplied). However, if the viscosity of the cleaning liquid is too high (e.g., more than 15 [mPa·s]), the cleaning liquid slips across the edge of the blade 14B and spots of cleaning liquid are left unwiped on the ink ejection face 52F. If such cleaning liquid left unwiped covers the ink ejection nozzles 521, it causes ejection failure (misdirected ejection).

To avoid that, the viscosity of the cleaning liquid is preferably 2 [mPa·s] or more but 15 [mPa·s] or less. This allows appropriate control of the cleaning operation for the ink ejection face 52F according to the properties of the cleaning liquid and the use conditions, operation status, and the like of the inkjet recording apparatus 1. Thus, it is possible to more effectively maintain the ink ejection performance of the recording head 52.

In addition, the static surface tension of the cleaning liquid is preferably lower than that of the ink. This effectively removes adhered ink on the ink ejection face 52F. Thus, it is possible to effectively prevent ink ejection failure in the ink ejection nozzles 521 and to suitably maintain the ink ejection performance of the recording head 52.

While the embodiment of the present disclosure is described above, it is not meant as any limitation on the scope of the present disclosure.

What is claimed is:

1. An inkjet recording apparatus comprising:
a recording head having an ink ejection face having a nozzle open therein through which to eject ink to a recording medium;
a cleaning liquid supplying device that supplies cleaning liquid to the ink ejection face;
a wiping unit that has a blade that cleans the ink ejection face; and
a control portion that controls operation of the recording head, the cleaning liquid supplying device, and the wiping unit,
wherein
the control portion is operable to perform cleaning operation to clean the ink ejection face through a combination of:
first wiping operation where only the ink is ejected to the ink ejection face, or the ink is ejected to and in addition the cleaning liquid is supplied to the ink ejection face, to be wiped off by the blade; and
second wiping operation where only the cleaning liquid is supplied to the ink ejection face to be wiped off by the blade, and,
in the cleaning operation,
control proceeds so as to perform the first wiping operation followed by the second wiping operation performed last to thereby complete the cleaning operation,
a wiping speed in the first wiping operation is equal to or more than a wiping speed in the second wiping operation, and
a wiping speed Wc [mm/s] for the cleaning liquid in the last, second wiping operation in the cleaning operation relative to a viscosity Vc [mPa·s] of the cleaning liquid is a speed that satisfies formula (1) below:
$$log Vc \geq ( - 4 \times Wc + 6 \; 70 ) / 1000. \qquad ( 1 )$$

2. The inkjet recording apparatus according to claim 1, wherein
in the cleaning operation, after the second wiping operation is performed at a speed lower than the wiping speed in the second wiping operation performed last, the first wiping operation is performed followed by the last, second wiping operation to complete the cleaning operation.

3. The inkjet recording apparatus according to claim 1, wherein
the viscosity of the cleaning liquid is 2 [mPa·s] or more but 15 [mPa·s] or less.

4. The inkjet recording apparatus according to claim 1, wherein
a static surface tension of the cleaning liquid is lower than that of the ink.
